(19) United States
(12) Patent Application Publication
(10) Pub. No.: US 2012/0133523 A1
(43) Pub. Date: May 31, 2012

(54) ANTI-THEFT DEVICE AND ANTI-THEFT METHOD

(75) Inventor: XIN GUO, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/233,185

(22) Filed: Sep. 15, 2011

(30) Foreign Application Priority Data
Nov. 25, 2010 (CN) 201010558860.9

(51) Int. Cl. G08B 21/00

(52) U.S. Cl. 340/687

(57) ABSTRACT

An anti-theft device includes an interface unit and an anti-theft unit. The interface unit includes a plurality of I/O ports for connecting external devices, and the interface unit and an anti-theft unit includes a detection unit, a comparison unit and an alert unit. The detection unit detects the current sequencing of at least two of the plurality of I/O ports being in a disconnected state with corresponding external devices. The comparison unit compares the current sequencing of at least two of the plurality of I/O ports being in a disconnected state with a predetermined sequencing of the at least two of the plurality of I/O ports being in a disconnected state. When the current sequencing of at least two of the plurality of I/O ports being in a disconnected state is different from the predetermined sequencing, the alert unit provides an alert.

### BACKGROUND

1. Technical Field

The present disclosure generally relates to anti-theft devices and anti-theft methods for these devices, and particularly to an electronic anti-theft device having a plurality of Input/Output (I/O) ports and an anti-theft method for the electronic anti-theft device.

2. Description of Related Art

Electronic devices having a plurality of I/O ports, such as televisions, display devices, mobile phones or portable notebooks, are widely used by people. Due to their value and portability, such electronic devices are accordingly in great risk of being stolen.

Taking notebooks for an example, various kinds of electronic locks for notebooks are available on the market. However, there are many problems in equipping a notebook with an electronic lock, and the electronic lock cannot inform users at the time of the theft. Therefore, the electronic lock is an ineffective deterrent against theft. An anti-theft method of the notebook is to set a password to unlock the notebook. However, this method merely prevents the reading or copying of files stored in the notebook, and cannot contribute to preventing a thief from taking the notebook.

What is needed, therefore, is an anti-theft device, and an anti-theft method for the device which can overcome the described limitations.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is a schematic block diagram of an anti-theft device according to an embodiment, the anti-theft device including an interface unit and an anti-theft unit, the anti-theft unit including a detection unit and a control unit.

FIG. 2 is a schematic block diagram of the interface unit, the detection unit and the control unit of the device in FIG. 1.

FIG. 3 is a flow chart of an anti-theft method for the device in FIG. 1.

FIG. 4 is a schematic block diagram of an anti-theft device according to another embodiment.

### DETAILED DESCRIPTION

Reference will be made to the drawings to describe the embodiments in detail.

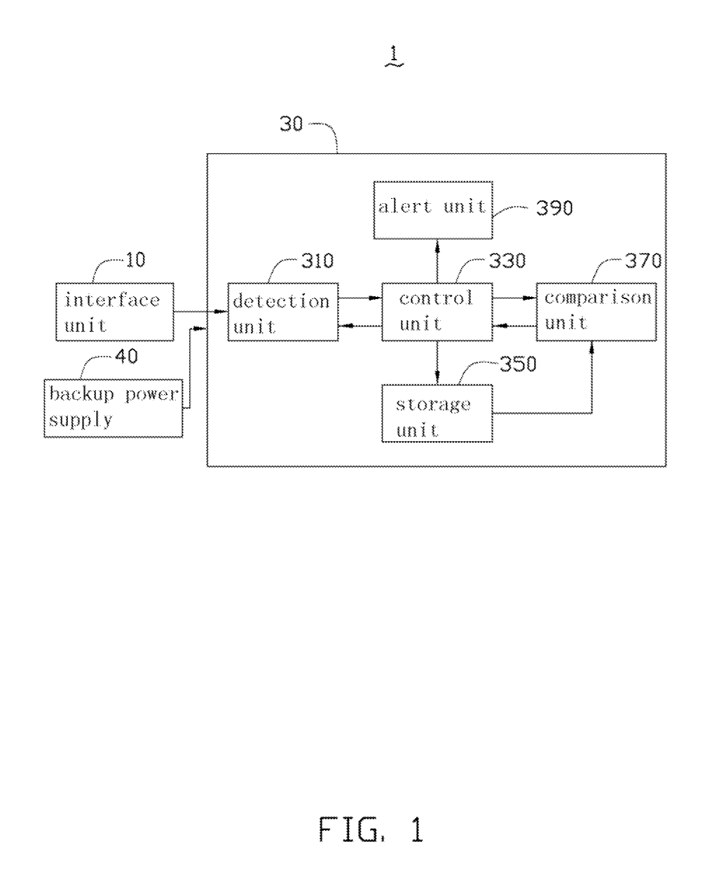

Referring to FIG. 1, a schematic block diagram of an anti-theft device 1 according to an embodiment is shown. The device 1 includes an interface unit 10, an anti-theft unit 30, and a backup power supply 40. The interface unit 10 is electrically connected to the anti-theft unit 30. The backup power supply 40 provides power to the anti-theft unit 30 when the device 1 is disconnected from an external power supply. The anti-theft unit 30 includes a detection unit 310, a control unit 330, a storage unit 350, a comparison unit 370, and an alert unit 390. The device 1 may be a device such as a television, a monitor or the like, or a portable device, such as notebook.

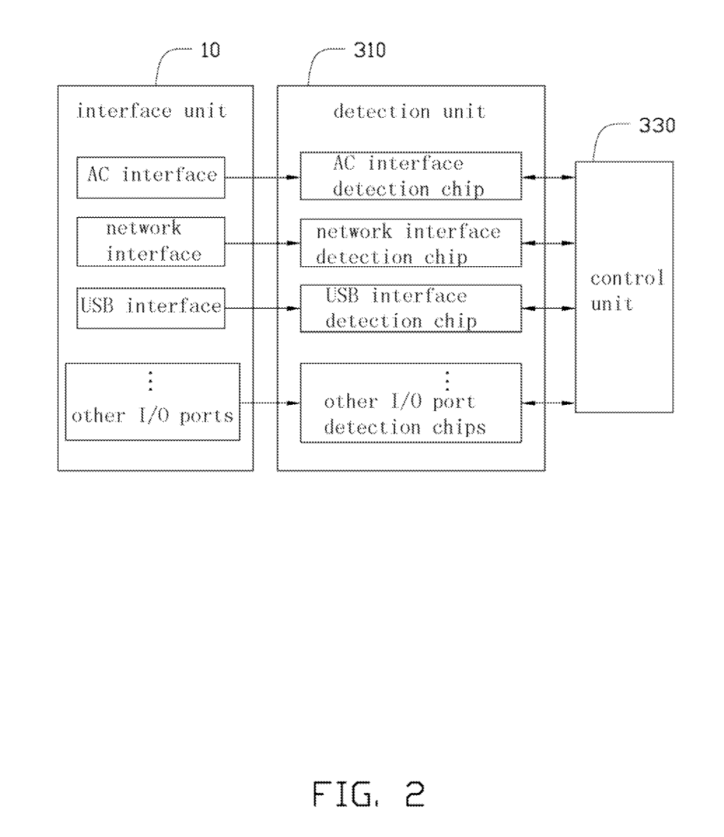

Referring to FIG. 2, a block diagram of the interface unit 10, the detection unit 310 and the control unit 330 in FIG. 1 is shown. The interface unit 10 includes a plurality of electrical in/out (I/O) ports. For example, the I/O ports may include an alternating current (AC) interface (not labeled), a universal serial bus (USB) interface (not labeled), a network interface (not labeled), and other I/O ports (not labeled) such as a parallel data interface, a microphone input, and a headset input (none of which shown). The I/O ports are used to electrically connect with the inputs or outputs of different external devices. For example, the AC interface can be used to connect to the external power supply.

The detection unit 310 may be a comparator in one example, and includes a plurality of I/O port detection chips for detecting states of the I/O ports of the interface unit 10, such as an AC interface detection chip (not labeled), a USB interface detection chip (not labeled), a network interface detection chip (not labeled), and other I/O port detection chips (not labeled). States of the I/O ports include a connected state or a disconnected state in relation to connection to any corresponding external devices. Each of the port detection chips is connected to one I/O port and detects the state of that I/O port. For example, the AC interface detection chip is connected to the AC interface by means of a pin of the AC interface detection chip being connected to a signal detection port of the AC interface. When the AC interface receives sufficient power from the external power supply, that is to say, the device 1 is in a connected state with the external power supply, the signal detection port of the AC interface is at a high level, such as 3.3 volts (3.3V). Accordingly, a high level signal (logic 1) is output to the pin of the AC interface detection chip from the signal detection port of the AC interface. Meantime, when the pin of the AC interface detection chip is at a high level, another pin of the AC interface detection chip outputs a high level voltage to the control unit 330. When the AC interface does not receive the power signal, that is to say, the device 1 is not connected to the external power supply, the signal detection port of the AC interface is at a low level, such as 0V. Accordingly, a low level signal (logic 0) is output to the pin of the AC interface detection chip from the signal detection port of the AC interface. When the pin of the AC interface detection chip is at a low level, another pin of the AC interface detection chip outputs a low level signal to the control unit 330. In a similar way, the USB interface detection chip and the network interface detection chip of the detection unit 310 are used to detect signals from the USB interface and the network interface to establish the states of the USB interface and the network interface.

A user can choose to turn on or turn off the anti-theft unit 30 according to his/her requirement. When the device 1 is powered on by being connected to the external power supply, if the user is physically close to the device 1, the user can turn off the anti-theft unit 30. If the user needs to leave the device 1 and set the device 1 in a stand-by state or shut it down, the user can turn on the anti-theft unit 30 via a software setting or a button disposed on the anti-theft unit 30.

When the anti-theft unit 30 is turned on, the control unit 330 outputs a detection signal to the detection unit 310, stores all detection results output from the detection unit 310 to the storage unit 350, and chooses a comparison mode according to each detection result. The comparison mode corresponds to the states of certain I/O ports as objects used for comparing, and is described in detail below. The control unit 330 controls the comparison unit 370 and the alert unit 390 according to the comparison mode.

The detection unit 310 receives the detection signal output from the control unit 330, and detects the states of the I/O ports of the interface unit 10 and a current sequencing of the I/O ports being in the disconnected state. The current sequencing of the I/O ports being in the disconnected state is defined as an order for disconnecting the I/O ports with the external devices at the time.

The storage unit 350 stores the states of the I/O ports of the interface unit 10 and the current sequencing of the I/O ports being in the disconnected state detected by the detection unit 310, and a predetermined sequencing of the I/O ports being in the disconnected state set by the user. The storage unit 350 may be a memory, such as read-only memory, random access memory, or the like. The user can preset different types of predetermined sequencing of the disconnected I/O ports via a control panel of a computer, and each type of the predetermined sequencing corresponds to a certain comparison mode. The total number of the comparison modes depends on the number of the I/O ports of the interface unit 10. For example, if the interface unit 10 includes “a” (e.g., “a” is a natural number greater than 2) I/O ports, the storage unit 350 can store Σ(Cₐ²+Cₐ³+Cₐ⁴+ . . . +Cₐ^{a-1}+Cₐ^{a}) comparison modes. More particularly, if the interface unit 10 includes five I/O ports such as an AC interface, a USB interface, a network interface, a headset input and a microphone input, the user can set Σ(C₅²+C₅³+C₅⁴+C₅⁵) comparison modes, where C₅⁵ represents the comparison mode corresponding to a predetermined sequencing of the five I/O ports being in the disconnection state set by the user, C₅⁴ represents the comparison mode corresponding to the predetermined sequencing set by the user of any random four I/O ports out of the five I/O ports being in the disconnection state set by the user, C₅³ represents the comparison mode corresponding to the predetermined sequencing of random three I/O ports out of the five I/O ports being in the disconnected state set by the user, and C₅² represents the comparison mode corresponding to the predetermined sequencing of random two I/O ports out of the five I/O ports being in a predetermined sequencing set by the user. Each comparison mode corresponds to a predetermined sequencing of at least two I/O ports being in the disconnection state set by the user.

Furthermore, when the user sets a predetermined sequencing of the I/O ports of the interface unit 10 via the control unit 330, the user firstly needs to define the I/O ports of the interface unit 10. For example, if the user wants to set a predetermined sequencing of the AC interface, the network interface and the USB interface of the interface unit 10 being in the disconnection state, the user can define the AC interface as 0001, the network interface as 0010, and the USB interface as 0011. The information defined in relation to the I/O ports is stored in corresponding address units of the storage unit 350. For example, a storage unit numbered “1” stores the defined information of the AC interface as 0001, a storage unit numbered “2” stores the defined information of the network interface as 0010, a storage unit numbered “3” stores the defined information of the USB interface as 0011, and a storage unit numbered “4” stores the defined information of the next defined I/O interface. After the user has completed defining the I/O ports, the predetermined sequencing(s) of the I/O ports being in the disconnection state is accordingly defined, and the predetermined sequencing is stored in another storage unit numbered “n” (e.g., n>10) of the storage unit 350. In addition, a storage unit numbered “n+m” (e.g., m>10) and the subsequent storage units store the current sequencing of the I/O ports being in the disconnected state detected by the detection unit 310 when the anti-theft unit 30 is turned on. That is to say, the storage unit numbered “n+m” stores the defined information of the I/O port being in the disconnected state firstly detected, the storage unit numbered “n+m+1” stores the defined information of the I/O port being in the disconnected state secondly detected, and the storage unit numbered “n+m+2” stores the defined information of the I/O port being in the disconnected state thirdly detected, and the system builds itself mutatis mutandis.

The comparison unit 370 compares the current sequencing of the I/O ports being in the disconnected state detected by the detection unit 310 with the predetermined sequencing of the I/O ports under a corresponding comparison mode. Particularly, when the detection unit 310 detects that all the I/O ports are disconnected, the detection unit 310 outputs the detection result to the control unit 330, and the control unit 330 outputs a comparison signal to the comparison unit 370, for the comparison unit 30 to compare the current sequencing of the I/O ports being in the disconnection state and the predetermined sequencing and output a corresponding comparison result. In an alternative embodiment, the detection unit 310 may directly output the detection result to the comparison unit 370 without going through the control unit 330. The comparison unit 370 receives the comparison signal, and reads the current sequencing of the I/O ports being in the disconnected state from the storage unit 350, simultaneously reads the predetermined sequencing of the I/O ports set by the user, obtains the comparison result, and outputs the comparison result to the control unit 330. In particular, the comparison unit 370 firstly subsequently reads the defined information of the I/O ports in the disconnected state currently detected from the address unit numbered “n+m” of the storage unit 350, the reading sequencing is the current sequencing of the I/O ports being in the disconnected state, and then reads the predetermined sequencing of the I/O ports from the storage unit 350 from the address unit numbered “n” as the beginning, and further obtains the comparison result by comparing the current sequencing of the I/O ports being in the disconnected state and the predetermined sequencing.

The control unit 330 receives the comparison result which has been output from the comparison unit 370. If the current sequencing of the I/O ports being in the disconnected state is same as the predetermined sequencing, then the disconnection of the I/O ports is determined to be a normal operation, and the control unit 330 does not output a signal to the alert unit 390. If the current sequencing of the I/O ports being in the disconnected state is different from the predetermined sequencing, the operation for disconnecting the I/O ports is defined as an abnormal operation, and the control unit 330 outputs a signal to the alert unit 390. The control unit 330 may be a central processing unit (CPU) or a microprocessor.

The alert unit 390 is electrically connected to the control unit 330 and receives the driving signal from the control unit 330 to provide an alert. The alert unit 390 may be an audio device disposed in the device 1, such as speaker, or a wireless communication module, and such a device will inform the user when the device 1 is subject to an abnormal operation. In an alternative embodiment, the alert unit 390 may be electrically connected to the comparison unit 370 and be directly driven by the comparison unit 370.

The backup power supply 40 provides power to the anti-theft unit 30 when the device 1 is powered off, that is to say, when the AC interface of the device 1 is disconnected or when a battery has been removed or is not available with the device 1, and thereby the anti-theft unit 30 can normally work even though the device 1 is has no normal power supply.

An operation of the device 1 is illustrated below, taking a comparison mode chosen corresponding to a predetermined sequencing of the AC interface, the USB interface and the network interface of the interface unit 10 being in the disconnection state being taken as an example.

After the anti-theft unit 30 is turned on, the control unit 330 detects whether the user sets a new predetermined sequencing of the I/O ports of the interface unit 10 being in the disconnected state. If the user does not set a new predetermined sequencing, the control unit 330 adopts the predetermined sequencing previously set by the user as the current predetermined sequencing. If the user sets and confirms a new predetermined sequencing, the control unit 330 sets the new predetermined sequencing as the current predetermined sequencing and stores the new predetermined sequencing in the storage unit 350. For example, if the predetermined sequencing set by the user is that the AC interface is disconnected firstly, and then the USB interface is disconnected, and then the network interface is disconnected, the control unit 330 subsequently reads the defined information 0001, 0011, 0010 which respectively represent the AC interface, the USB interface and the network interface from the corresponding address units numbered “1”, “3”, “2”, processes the information which represents the predetermined sequencing, and then stores the information to the corresponding address unit numbered “n” of the storage unit 350. For example, if the address unit numbered “n” has 16 bits, the information representing the I/O port being disconnected firstly is stored in the lower 4 bits of the lower 8 bits of the 16 bits, the information representing the I/O port being disconnected secondly is stored in the higher 4 bits of the lower 8 bits of the 16 bits, the information representing the I/O port being thirdly in the disconnected state is stored in the lower 4 bits of the higher 8 bits of the 16 bits, and the other bits of the 16 bits are set to 0. Therefore, when the AC interface is set to be firstly in the disconnected state, the USB interface is set to be secondly in the disconnected state and the network interface is set to be thirdly in the disconnected state, the information representing the predetermined sequencing is stored in the form of 0000001000110001.

Furthermore, the control unit 330 outputs a detection signal to the detection unit 310 for detecting the states of the I/O ports. It is necessary that at least two I/O ports are connected when the anti-theft unit 30 is turned on. The detection unit 310 detects the states of the I/O ports, and outputs a detection result to the control unit 330. The control unit 330 stores the information representing the I/O ports in the connected state when the anti-theft unit 30 is turned on and the number of the I/O ports in the connected state to the storage unit 350, and chooses a comparison mode corresponding to the predetermined sequencing of the I/O ports being in the disconnected state set by the user from the storage unit 350. For example, when the anti-theft unit 30 is turned on, the AC interface, the USB interface and the network interface of the interface unit 10 are connected, the control unit 330 stores the defined information of the AC interface, the USB interface and the network interface and number 3 as the number of interfaces which are connected to the storage unit 350, and chooses the comparison mode corresponding to the predetermined sequencing when three of the I/O ports are disconnected.

When the detection unit 310 detects the USB interface being firstly in the disconnected state, the pin of the USB interface detection chip of the detection unit 310 is switched to a low level state, and outputs a low level signal to the control unit 330. The control unit 330 stores the define information of the USB interface as 0011 to the address unit numbered “n+m” of the storage unit 350, such as, in a form of 00000011. In addition, the control unit 330 controls the storage unit 350 to subtract 1 from the number of the I/O ports in the connected state when the anti-theft unit 30 is turned on. Then the detection unit 310 continues detecting the states of only the AC interface and the network interface.

When the detection unit 310 detects the AC interface being secondly in the disconnected state, the control unit 330 stores the defined information of the AC interface as 0001 to the address unit numbered “n+m+1” of the storage unit 350 as 00000001. The control unit 330 also subtracts 1 from the number of the I/O ports in the connected state as recorded in the unit 350.

When the detection unit 310 continues detecting the states of the network interface being third in the disconnected state, the control unit 330 stores the defined information of the network interface as 0010 to the address unit numbered “n+m+2” of the storage unit 350 in the form 00000010. Meantime, the control unit 330 continues controlling the storage unit 350 to subtract 1 from the number of the I/O ports in the connected state. Accordingly, the number of the I/O ports in the connected state becomes 0. That is to say, all the I/O ports are in the disconnected state. The control unit 330 processes the information stored in the storage unit 330. For example, the control unit 330 transforms the information representing the USB interface being firstly in the disconnected state into a first 16 bits of data, that is, 0000000000000011, transforms the information representing the AC interface being secondly in the disconnected state into a second 16 bits of data, that is, 0000000000010000, transforms the information representing the network interface being thirdly in the disconnected state into a third 16 bits of data, that is, 0000000100000000, and implements an “add” operation on the first, the second and the third 16 bits of data to obtain an operation result, that is, 0000001000010011=Σ(0000000000000011+0000000000010000+0000001000000000). In an alternative embodiment, the transformed information can be represented by 8 bits of binary code or by 32 bits of binary code, and the control unit 330 can implement another operation, such as an “and” operation.

When the number of the I/O ports in the connected state becomes 0, the control unit 330 outputs a comparison signal to the comparison unit 370. The comparison unit 370 reads the operation result 0000001000010011 representing the current sequencing of the AC interface, the USB interface and the network interface being in the disconnected state and 0000001000110001 representing the predetermined sequencing of the 3 I/O ports set by the user, and implements a comparison. If all the bits of the “and” operation result in “1”, that is to say, the current sequencing of the AC interface, the USB interface and the network interface being in the disconnected state is the same as the predetermined sequencing of the 3 I/O ports set by the user, the disconnecting operation is defined as a normal operation. If any one or more bits of the “and” operation have a result other than “1”, that is to say, the current sequencing of the AC interface, the USB interface and the network interface being in the disconnected state is different from the predetermined sequencing of the 3 I/O ports set by the user, the operation for disconnecting the I/O ports is defined as an abnormal operation. After the comparison unit 370 compares the current sequencing of the AC interface, the USB interface and the network interface being in the disconnected state and the predetermined sequencing of the 3 I/O ports set by the user, the comparison unit 370 outputs a comparison result to the control unit 330.

The control unit 330 receives the comparison result output from the comparison unit 370. When the comparison result shows that the operation is normal, the control unit 330 does not output a driving signal to the alert unit 390. When the comparison result shows that the operation is abnormal, the control unit 330 outputs the driving signal to the alert unit 390, and the alert unit 390 provides an alert to the user.

The device 1 can operate in this self-protection mode (against being stolen) merely by means of its interior configuration. Therefore, the device 1 does not need other exterior anti-theft and alert elements and the cost of the device 1 is decreased. Furthermore, normal operation is defined by the user in predetermining the sequencing of the I/O ports being in the disconnected state, if the user needs to move the device 1, the user can disconnect the I/O ports of the device 1 according to the predetermine sequencing, and the device 1 does not sound an alarm.

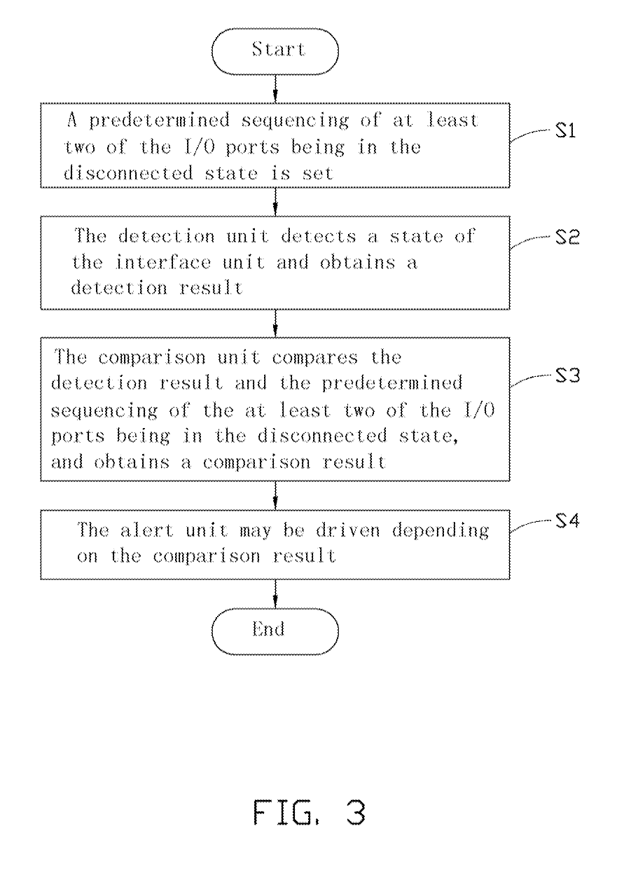

Referring to FIG. 3, a flow chart of an anti-theft method for the device 1 in FIG. 1 is shown. The method includes the following steps described as below.

In step S1, a predetermined sequencing of at least two of the I/O ports being in the disconnected state is set. The user can set the predetermined sequencing of the at least two of the I/O ports being in the disconnected state at the time when he/she is using the device 1 or can maintain a previous predetermined sequencing of the at least two of the I/O ports. When the user sets the predetermined sequencing of the at least two of the I/O ports being in the disconnected state, the user needs to define the I/O ports of the interface unit 10 and store the defined information of the I/O ports to the corresponding address units of the storage unit 350 according to a predetermined sequencing.

In step S2, the detection unit 310 detects a state of the interface unit 10 and obtains a detection result. When the anti-theft unit 30 is turned on, the control unit 330 outputs a detection signal to the detection unit 310. The detection unit 310 detects the current sequencing of the I/O ports being in the disconnected state and outputs the detection result to the comparison unit 370 directly or via the control unit 330. The detection result includes the information representing the current sequencing of the I/O ports being in the disconnected state.

In step S3, the comparison unit 370 compares the detection result and the predetermined sequencing of the at least two of the I/O ports being in the disconnected state, and obtains a comparison result.

In step S4, the alert unit 390 may be driven, depending on the comparison result. If the current sequencing of the at least two of the I/O ports being in the disconnected state is the same as the predetermined sequencing, that is to say, the current operation for disconnecting the I/O ports is normal, the control unit 330 does not output a driving signal to the alert unit 390. If the current sequencing of the at least two of the I/O ports being in the disconnected state is different from the predetermined sequencing, that is to say, the current operation for disconnecting the I/O ports is determined to be abnormal, then the control unit 330 outputs a driving signal to the alert unit 390. The driving signal can be provided by the control unit 330, or can be directly provided by the comparison unit 370.

Furthermore, the method further includes a step for choosing a comparison mode after the step S1. After the anti-theft unit 30 is turned on, the control unit 330 outputs a detection signal to the detection unit 310 to detect the I/O ports in the connected state when the anti-theft unit 30 is turned on and the number of the I/O ports in the connected state, stores the detection result to the storage unit 350, and chooses a comparison mode according to the I/O ports in the connected state and the number of the I/O ports in the connected state. The comparison mode corresponds to a predetermined sequencing of at least two of the I/O ports being in the disconnected state set by user.

The method further includes a step before step S3. The detection unit 310 outputs the detection result to the control unit 330, the control unit 330 stores the sequencing of the I/O ports in the connected state. Further, when the anti-theft unit 30 is turned on the detection unit 310 establishes which I/O ports are not connected and stores the individual port information in a corresponding address unit of the storage unit 350.

In addition, after the step of storing, the method further includes a step for confirming whether or not all the I/O ports in the connected state when the anti-theft unit 30 is turned on, are currently in the disconnected state. When the anti-theft unit 30 is turned on, the control unit 330 outputs a detection signal to the detection unit 310 to detect the states of the I/O ports, and stores the number of the I/O ports in the connected state to the storage unit 350. When the detection unit 310 detects that one of the I/O ports in the connected state being in the disconnected state, the number of the I/O ports stored in the storage unit 350 subtracts 1. Until the number becomes 0, that is to say, until all the I/O ports in the connected state when the anti-theft unit 30 is turned on are currently in the disconnected state, the control unit 330 outputs the comparison signal to the comparison unit 370.

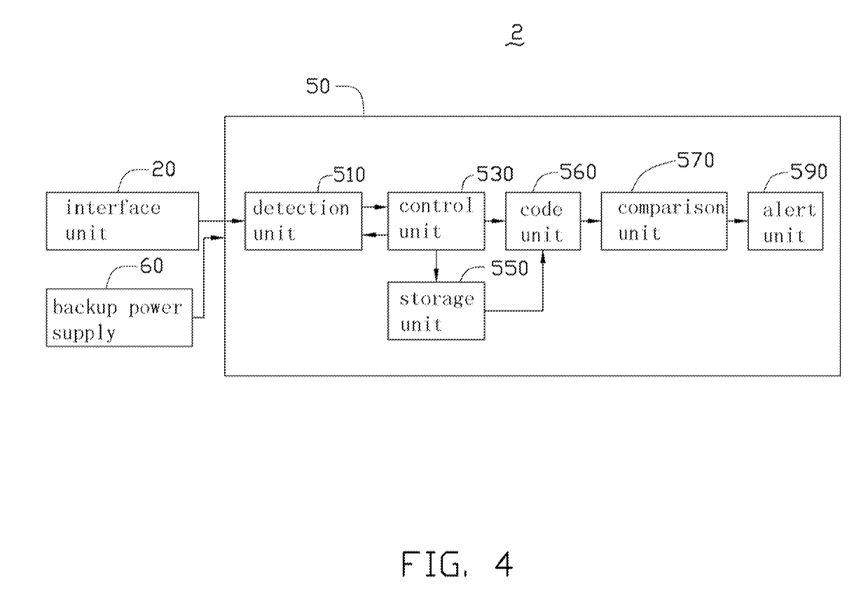

Referring to FIG. 4, a block diagram of an anti-theft device according to another embodiment is shown. The device 2 is similar to the device 1, and includes an interface unit 20, a backup power supply 60 and an anti-theft unit 50. The anti-theft unit 50 also includes a detection unit 510, a control unit 530, a storage unit 550, a comparison unit 570, and an alert unit 390. However, the anti-theft unit 50 of the device 2 further includes a code unit 560 in comparison with the anti-theft unit 30 of the device 1.

The code unit 560 may be a coder, and is electrically connected to the control unit 530, the storage unit 550 and the comparison unit 570. The code unit 560 receives a coding signal output from the control unit 530, and reads information representing the I/O ports of the interface unit 20 as predefined by a user from the corresponding address units of the storage unit 550 according to the current sequencing of the I/O ports being in a disconnected state. Furthermore, the code unit 560 subsequently codes the information representing the I/O ports of the interface unit 20 according to the current sequencing of the I/O ports being in a disconnected state to generate a first timing wave, the first timing wave representing the current sequencing of the I/O ports being in the disconnected state, and outputs the first timing wave to the comparison unit 570. Meantime, the code unit 560 reads and codes information representing a predetermined sequencing of the I/O ports being in the disconnected state set by the user to generate a second timing wave, the second timing wave representing the predetermined sequencing of the I/O ports being in the disconnected state set by the user, and outputs the second timing wave to the comparison unit 570. The comparison unit 570 compares the first and the second timing waves, and outputs a comparison result to the alert unit 390. If the first and the second timing waves are the same, that is to say, the current operation for disconnecting the I/O ports is normal, the comparison unit 570 does not output a driving signal to the alert unit 590. If the first and the second timing waves are different, that is to say, the current operation for disconnecting the I/O ports is determined to be abnormal, the comparison unit 570 outputs the driving signal to the alert unit 590 for providing an alert.

In an alternative embodiment, the comparison unit 570 can output the comparison result to the control unit 530. If the first and the second timing waves are the same, the control unit 530 does not output the driving signal to the alert unit 590. If the first and the second timing waves are different, the control unit 530 outputs the driving signal to the alert unit 590 to broadcast an alert.

Accordingly, an anti-theft method for the device 2 is similar to the method for the device 1, however, the method for the device 2 further includes a step for coding.

That is to say, after the detection result output from the detection unit 510 has been stored, the control unit 530 outputs the coding signal to the code unit 560. The code unit 560 reads and codes the information representing the current sequencing of the I/O ports being in the disconnected state to generate the first timing wave, reads and codes the information representing the predetermined sequencing of the I/O ports being in the disconnected state set by the user to generate the second timing wave, and outputs the first and the second timing waves to the comparison unit 570.

It is believed that the present embodiments and their advantages will be understood from the foregoing description, and it will be apparent that various changes may be made thereto without departing from the spirit and scope of the embodiments or sacrificing all of their material advantages.

What is claimed is:

1. A device, comprising:
an interface unit, the interface unit comprising a plurality of In/Out (I/O) ports; and
an anti-theft unit, the anti-theft unit comprising a detection unit, a comparison unit, and an alert unit;
wherein the detection unit is configured to detect a current sequencing of at least two of the plurality of I/O ports being in a disconnected state with external devices correspondingly connected to the at least two of the plurality of I/O ports, the comparison unit is configured to compare the current sequencing of the at least two of the plurality of I/O ports being in the disconnected state with a predetermined sequencing of the at least two of the plurality of I/O ports being in the disconnected state, and when the current sequencing of at least two of the plurality of I/O ports being in the disconnected state is different from the predetermined sequencing, the alert unit is configured to provide an alert.

2. The device of claim 1, wherein the at least two of the plurality of I/O ports is in a connected state with the corresponding external devices when the anti-theft unit is turned on.

3. The device of claim 2, wherein the anti-theft unit further comprises a storage unit, the storage unit configured to store the current sequencing of at least two of the plurality of I/O ports being in the disconnected state and the predetermined sequencing of the at least two of the plurality of I/O ports being in the disconnected state.

4. The device of claim 3, wherein the detection unit is further configured to detect states of the plurality of I/O ports when the anti-theft unit is turned on.

5. The device of claim 4, wherein the storage unit is further configured to store the number of the I/O ports in the connected state anti-theft unit is turned on.

6. The device of claim 5, wherein the storage unit is further configured to store a plurality of comparison modes, each comparison mode corresponding to one predetermined sequencing of at least two of the plurality of I/O ports being in the disconnected state.

7. The device of claim 6, wherein the number of the plurality of comparison modes depends on the number of the plurality of I/O ports.

8. The device of claim 6, wherein the anti-theft unit further comprises a control unit, the control unit configured to choose a comparison mode according to the states of the plurality of I/O ports when the anti-theft unit is turned on and control the detection unit, the storage unit, the comparison unit and the alert unit to operate.

9. The device of claim 1, wherein the anti-theft unit further comprises a code unit, the code unit configured to respectively code the current sequencing of at least two of the plurality of I/O ports being in the disconnected state and the predetermined sequencing of the at least two of the plurality of I/O ports being in the disconnected state to generate a first timing wave and a second timing wave and output the first and the second timing waves to the comparison unit.

10. The device of claim 1, further comprising a backup power supply, wherein the backup power supply is configured to provide power to the anti-theft unit when the device is powered off.

11. An anti-theft method for a device, the device comprising a plurality of In/Out (I/O) ports and an anti-theft unit, the method comprising:
detecting a current sequencing of at least two of the plurality of I/O ports being in a disconnected state with external devices correspondingly connected to the at least two of the plurality of I/O ports;
comparing the current sequencing of the at least two of the plurality of I/O ports being in the disconnected state with a predetermined sequencing of the at least two of the plurality of I/O ports being in the disconnected state; and
providing an alert when the current sequencing of at least two of the plurality of I/O ports being in the disconnected state is different from the predetermined sequencing.

12. The anti-theft method of claim 11, further comprising detecting states of the plurality of I/O ports when the anti-theft unit is turned on.

13. The anti-theft method of claim 12, further comprising storing the number of the I/O ports in the connected state anti-theft unit is turned on, the predetermined sequencing of the at least two of the plurality of I/O ports being in the disconnected state, and the current sequencing of the at least two of the plurality of I/O ports being in the disconnected state

14. The anti-theft method of claim 13, further comprising subtracting 1 from the number of the I/O ports in the connected state when one of the I/O ports is detected from the connected state to the disconnected state.

15. The anti-theft method of claim 14, wherein comparing the current sequencing of at least two of the plurality of I/O ports being in the disconnected state with a predetermined sequencing of the at least two of the plurality of I/O ports being in the disconnected state when the number of the I/O ports becomes 0.

16. The anti-theft method of claim 13, further comprising coding the current sequencing of at least two of the plurality of I/O ports being in the disconnected state and the predetermined sequencing of the at least two of the plurality of I/O ports being in the disconnected state and generating a first timing wave and a second timing wave.

17. The anti-theft method of claim 16, further comprising comparing the first timing wave with the second timing wave.

18. The anti-theft method of claim 17, wherein providing the alert when the first timing wave is different from the second timing wave.

19. The anti-theft method of claim 11, further comprising judging whether states of all the plurality of I/O ports are in the disconnected state.

20. The anti-theft method of claim 19, wherein comparing the current sequencing of at least two of the plurality of I/O ports being in the disconnected state with a predetermined sequencing of the at least two of the plurality of I/O ports being in the disconnected state when the states of all the plurality of I/O ports are in the disconnected state.
